(19) United States
(12) Patent Application Publication
(10) Pub. No.: US 2026/0200950 A1
(43) Pub. Date: Jul. 16, 2026

(54) POROUS ORGANOMETALLIC COMPOUND PARTICLE, METHOD FOR PREPARING THE SAME, ANODE FOR SECONDARY BATTERY, AND LITHIUM SECONDARY BATTERY

(71) Applicants: SK ON CO., LTD., Seoul (KR); INDUSTRY-UNIVERSITY COOPERATION FOUNDATION HANYANG UNIVERSITY, Seoul (KR)

(72) Inventors: Bit Na CHOI, Daejeon (KR); Na Eun YOON, Daejeon (KR); Jong Won LEE, Seoul (KR); Hong Rim SHIN, Seoul (KR); Beom Su KIM, Jeollabuk-do (KR); Yong Hoon AN, Seoul (KR)

(21) Appl. No.: 19/450,735

(22) Filed: Jan. 16, 2026

(30) Foreign Application Priority Data
Jan. 16, 2025 (KR) 10-2025-0006915

(51) Int. Cl. C07F 3/06; H01M 4/02; H01M 4/139; H01M 4/60; H01M 10/052

(52) U.S. Cl. CPC C07F 3/06; H01M 4/139; H01M 4/60; H01M 10/052; H01M 2004/021; H01M 2004/027; H01M 2300/008

(57) ABSTRACT

A porous organometallic compound particle according to the present disclosure includes carbon, nitrogen, and a metal and has a median particle diameter of 100 nm or more and less than 200 nm. According to a method for preparing a porous organometallic compound particle of the present disclosure, a metal precursor solution is added to a nitrogen-containing organic ligand precursor solution to precipitate a metal-organic framework. The metal-organic framework is obtained and then heat-treated. A ratio of a weight of the nitrogen-containing organic ligand in the nitrogen-containing organic ligand precursor solution to a weight of the metal precursor in the metal precursor solution is 4.7 or more.

### CROSS-REFERENCE TO RELATED APPLICATIONS

This patent application claims the priority and benefits of Korean Patent Application No. 10-2025-0006915 filed on Jan. 16, 2025, the disclosure of which is incorporated herein by reference in its entirety.

### BACKGROUND OF THE INVENTION

### 1. Field of the Invention

The present disclosure relates to a porous organometallic compound particle, a method for preparing the same, an anode for a secondary battery, and a lithium secondary battery including the anode.

### 2. Description of the Related Art

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as hybrid vehicles.

Examples of secondary batteries may include a lithium secondary battery, a nickel-cadmium battery, and a nickel-hydrogen battery. Among these, the lithium secondary battery has been actively developed and applied due to its high operating voltage, high energy density per unit weight, and advantages in charging speed and weight reduction.

Since commercially available lithium secondary batteries mainly use liquid electrolytes, there are safety issues such as leakage, ignition, and explosion due to sudden environmental changes, including temperature fluctuations, external impacts and the like. To address these problems, research has been conducted to solidify the electrolyte, thereby enhancing stability and increasing energy density.

All-solid-state batteries may include solid-state electrolytes such as gel polymers, oxides, sulfides, or composite polymers as electrolytes. Accordingly, stability against ignition and explosion caused by external impacts or external environmental fluctuations may be enhanced.

### SUMMARY OF THE INVENTION

An object of the present disclosure is to provide a porous organometallic compound particle having improved mechanical properties.

Another object of the present disclosure is to provide a method for preparing the porous organometallic compound particle.

Yet another object of the present disclosure is to provide an anode for a secondary battery including the porous organometallic compound particle.

Still another object of the present disclosure is to provide a lithium secondary battery including the anode for a secondary battery.

A porous organometallic compound particle according to the present disclosure includes carbon, nitrogen, and a metal and has a median particle diameter of 100 nm or more and less than 200 nm.

According to exemplary embodiments, the porous organometallic compound particle may have a median particle diameter of 100 nm to 160 nm.

According to exemplary embodiments, the porous organometallic compound particle may have a rhombic dodecahedron structure.

According to exemplary embodiments, the metal may include one or more of Zn, Co, Cu, Ti, Hf, Zr, Ni, Mg, V, Cr, Fe and Al.

According to exemplary embodiments, the metal may include a first metal including one or more of Zn, Co, Cu, Ti, Hf, Zr, Ni, Mg, V, Cr, Fe and Al, and a second metal including one or more of Pt, Al, Mg, Zn, Ag Au, Si, Sb and Sn.

According to a method for preparing a porous organometallic compound particle of the present disclosure, a metal precursor solution is added to a nitrogen-containing organic ligand precursor solution to precipitate a metal-organic framework. The metal-organic framework is obtained and then heat-treated. A ratio of a weight of the nitrogen-containing organic ligand in the nitrogen-containing organic ligand precursor solution to a weight of the metal precursor in the metal precursor solution is 4.7 or more.

According to exemplary embodiments, the ratio of the weight of the nitrogen-containing organic ligand in the nitrogen-containing organic ligand precursor solution to the weight of the metal precursor in the metal precursor solution may be 5 to 10.

According to exemplary embodiments, the content of the metal precursor in the metal precursor solution may be 0.01 g/mL to 0.2 g/mL.

According to exemplary embodiments, the content of the nitrogen-containing organic ligand in the nitrogen-containing organic ligand precursor solution may be 0.2 g/mL to 1 g/mL.

According to exemplary embodiments, the heat treatment may be performed at a temperature of 700° C. to 1,000° C. for 1 to 3 hours.

According to exemplary embodiments, the method may further include preparing a porous organometallic compound particle including a second metal using a second metal precursor solution after the heat treatment.

An anode for a secondary battery according to the present disclosure includes: an anode current collector; and an anode mixture layer disposed on one surface of the anode current collector and including a porous organometallic compound particle containing carbon, nitrogen, and a metal and having a median particle diameter of 100 nm or more and less than 200 nm.

According to exemplary embodiments, the content of the porous organometallic compound particle may be 60% by weight to 95% by weight based on a total weight of the anode mixture layer.

According to exemplary embodiments, the anode may further include a metal layer interposed between the anode mixture layer and the anode current collector.

According to exemplary embodiments, the metal layer may include at least one selected from the group consisting of Ag, Zn, Al, Mg, Au, Si and Sb.

According to exemplary embodiments, the anode mixture layer may further include a binder or a conductive material.

A lithium secondary battery according to the present disclosure includes: the anode; and a cathode disposed opposite the anode.

According to exemplary embodiments, the secondary battery may further include a solid electrolyte layer interposed between the anode and the cathode.

The porous organometallic compound particle of the present disclosure may induce lithium metal to be electrodeposited between the anode current collector and the anode mixture layer, and may suppress the formation of lithium dendrites.

The porous organometallic compound particle of the present disclosure may prevent an increase in the volume of the electrode assembly during repeated charge and discharge cycles of the battery. Accordingly, an excessive increase in the internal pressure of the battery may be prevented.

The porous organometallic compound particle of the present disclosure may improve the reversibility of the lithium electrodeposition reaction during charge and discharge of the battery.

A secondary battery anode including the porous organometallic compound particle of the present disclosure may have improved volume stability.

The lithium secondary battery of the present disclosure may have enhanced initial charge and discharge efficiency and improved cycle life characteristics.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a schematic cross-sectional view illustrating a secondary battery according to exemplary embodiments;

FIG. 2 is a transmission electron microscope (TEM) image of porous organometallic compound particles of Example A;

FIG. 3 is a TEM image of the porous organometallic compound particles of Example B;

FIG. 4 is a TEM image of the porous organometallic compound particles of Example C;

FIG. 5 is a TEM image and EDS elemental mapping images of carbon, zinc, and silver of a porous organometallic compound particle of Example D;

FIG. 6 is a TEM image of the porous organometallic compound particles of Comparative Example A;

FIG. 7 is a TEM image of the porous organometallic compound particles of Comparative Example B;

FIG. 8 is a scanning electron microscope (SEM) image of a cross-section of an anode of Example 1 after charging;

FIG. 9 is a SEM image of a cross-section of an anode of Comparative Example 1 after charging;

FIG. 10 is an SEM image of a cross-section of an anode of Example 5 after charging;

FIG. 11 is an SEM image of a cross-section of an anode of Example 8 after charging; and

FIG. 12 is a graph of charge-discharge curves for Example 1 and Comparative Example 1 according to capacity.

### DETAILED DESCRIPTION

According to the present disclosure, a porous organometallic compound particle including carbon, nitrogen, and a metal is provided. In addition, an anode for a secondary battery including the porous organometallic compound particle and a lithium secondary battery including the anode for a secondary battery are provided.

Hereinafter, exemplary embodiments of the present disclosure will be described in detail with reference to the accompanying drawings. However, these embodiments are merely illustrative, and the present disclosure is not limited to the specific embodiments described as examples.

The porous organometallic compound particle according to the present disclosure includes carbon, nitrogen, and a metal. For example, the porous organometallic compound particle may include metal particles dispersed in a matrix including carbon and nitrogen.

The porous organometallic compound particle has a median particle diameter of 100 nm or more and less than 200 nm. In exemplary embodiments, the porous organometallic compound particle may have a median particle diameter of 100 nm to 160 nm.

Within the above range, lithium metal may be induced to be electrodeposited between an anode current collector and an anode mixture layer, and the formation of lithium dendrites may be suppressed. The anode mixture layer, which includes an anode active material, a binder, and a conductive material, may refer to an anode active material layer.

If the median particle diameter of the porous organometallic compound particle is less than 100 nm, a porous structure may not be formed.

If the median particle diameter of the porous organometallic compound particle is 200 nm or more, lithium may be electrodeposited on the anode mixture layer, and lithium dendrites may be formed, thereby deteriorating battery cycle life characteristics.

For example, the median particle diameter (D50) may be measured using a laser diffraction method. Specifically, the median particle diameter (D50) may be calculated by dispersing the target particles in a dispersion medium, introducing the dispersion into a commercially available laser diffraction particle size measuring device (e.g., Microtrac MT 3000), irradiating the dispersion with ultrasonic waves of about 28 kHz at an output of 60 W, and then calculating the median particle diameter (D50) based on the 50% point of the cumulative particle volume-based distribution according to particle size measured by the device.

According to exemplary embodiments, the porous organometallic compound particle may have a polyhedral shape having a rhombic dodecahedron structure.

According to exemplary embodiments, the metal may include one or more of Zn, Co, Cu, Ti, Hf, Zr, Ni, Mg, V, Cr, Fe and Al. According to some embodiments, the metal may include one or more of Zn, Co, Mg and Al. For example, the metal may include Zn.

The metal may have high lithium affinity, thereby enabling efficient electrodeposition of lithium within the pores of the porous organometallic compound particle.

According to exemplary embodiments, the metal may include two or more different metals. For example, the metal may include two or more different metals having different lithium affinities. Accordingly, an initial nucleation energy of lithium electrodeposition may be reduced, thereby facilitating lithium electrodeposition between the anode current collector and the anode mixture layer.

According to exemplary embodiments, the metal may include a first metal including one or more of Zn, Co, Cu, Ti, Hf, Zr, Ni, Mg, V, Cr, Fe and Al, and a second metal including one or more of Pt, Al, Mg, Zn, Ag, Au, Si, Sb and Sn. According to some embodiments, the first metal may include one or more of Zn, Co, Mg and Al, and the second metal may include one or more of Mg, Zn, Ag, Au, Si and Sn. For example, the first metal may include Zn, and the second metal may include Ag.

The metal content based on a total weight of the porous organometallic compound particles may be 1 wt % to 30 wt %. For example, the metal content based on the total weight of the porous organometallic compound particles may be 3 wt % to 20 wt %.

According to the method for preparing a porous organometallic compound particle of the present disclosure, a metal precursor solution is added to a nitrogen-containing organic ligand precursor solution to precipitate a metal-organic framework. The metal precursor solution may be a first metal precursor solution.

A ratio of a weight of the nitrogen-containing organic ligand in the nitrogen-containing organic ligand precursor solution to a weight of the metal precursor in the metal precursor solution may be 4.7 or more. According to exemplary embodiments, the ratio of the weight of the nitrogen-containing organic ligand in the nitrogen-containing organic ligand precursor solution to the weight of the metal precursor in the metal precursor solution may be 5 to 10 or 5.5 to 8.

Within the above range, porous organometallic compound particles having appropriate sizes and porosity may be formed.

If the ratio of the weight of the nitrogen-containing organic ligand in the nitrogen-containing organic ligand precursor solution to the weight of the metal precursor in the metal precursor solution is less than 4.7, excessively large porous organometallic compound particles may be formed. Accordingly, lithium may be electrodeposited on a surface of the anode mixture layer, resulting in lithium dendrite formation and deterioration of battery cycle life characteristics.

According to exemplary embodiments, the content of the metal precursor in the metal precursor solution may be 0.01 g/mL to 0.2 g/mL. According to some embodiments, the content of the metal precursor in the metal precursor solution may be 0.03 g/mL to 0.1 g/mL or 0.03 g/mL to 0.5 g/mL.

According to exemplary embodiments, the content of the nitrogen-containing organic ligand in the nitrogen-containing organic ligand precursor solution may be 0.2 g/mL to 1 g/mL. According to some embodiments, the content of the nitrogen-containing organic ligand in the nitrogen-containing organic ligand precursor solution may be 0.3 g/mL to 0.7 g/mL or 0.3 g/mL to 0.5 g/mL.

The metal precursor may be a metal salt compound including ions of one or more metals selected from Zn, Co, Cu, Ti, Hf, Zr, Ni, Mg, V, Cr, Fe and Al. For example, the metal precursor may be a metal nitrate, metal acetate, metal sulfate, metal nitrite, metal sulfite, metal carbonate, or metal halide. The metal precursor may be the first metal precursor.

The nitrogen-containing organic ligand may include a nitrogen-carbon multiple bond. For example, the nitrogen-containing organic ligand may include a pyridine compound, an imidazole compound, a nitrile compound or the like. These may be used alone or in combination of two or more thereof.

As used herein, the term “solution” may mean a homogeneous mixture of a solvent and a solute. The solvent may be a polar solvent, for example, acetone, methanol, ethanol, or water.

According to exemplary embodiments, the metal precursor solution may be added to the nitrogen-containing organic ligand precursor solution at a rate of 5 mL/s to 30 mL/s. For example, the metal precursor solution may be added to the nitrogen-containing organic ligand precursor solution at a rate of 10 mL/s to 25 mL/s. Within this range, porous organometallic compound particles having a median particle diameter of 100 nm or more and less than 200 nm may be prepared.

The metal precursor solution may be added to the nitrogen-containing organic ligand precursor solution with stirring to precipitate a metal-organic framework. For example, the metal-organic framework may be precipitated by stirring for about 10 minutes to 90 minutes after the addition.

The metal-organic framework may be obtained from a mixture including the precipitated metal-organic framework. For example, the metal-organic framework may be obtained by filtering, washing centrifugation, and drying the mixture.

The filtration, washing, and centrifugation steps may be performed independently and repeatedly, or washing and centrifugation may be performed sequentially and repeatedly multiple times.

The temperature and time of the drying may be adjusted based on the boiling point of the solvent. For example, when the solvent is water, the drying may be performed at a temperature of about 70° C. to 90° C. for about 5 to 10 hours.

The obtained metal-organic framework may be heat-treated. During the heat treatment, an unstable carbon structure of the metal-organic framework may be stabilized, thereby forming a porous structure.

According to exemplary embodiments, the heat treatment may be performed at a temperature of 700° C. to 1,000° C. for 1 hour to 3 hours. Within this range, destruction of a pore structure may be prevented.

The heat treatment may be performed under an inert gas atmosphere. For example, the heat treatment may be performed under an inert gas atmosphere such as Ar or He.

According to exemplary embodiments, the method may further include a step of preparing a porous organometallic compound particle including a second metal using a second metal precursor solution after the heat treatment.

The second metal precursor may be a metal salt compound including ions of one or more metals selected from the group consisting of Pt, Al, Mg, Zn, Ag, Au, Si, Sb and Sn. For example, the second metal precursor may include an Ag salt.

For example, the porous organometallic compound particles may be added to the second metal precursor solution and stirred for about 5 hours to 20 hours. The mixture may be reacted for a relatively long period of time, and second metal ions of the second metal precursor may replace a portion of a metal in the porous organometallic compound particles, for example, a portion of the first metal.

A ratio of a weight of the porous organometallic compound particles to a weight of the second metal precursor in the second metal precursor solution may be 1.5 to 5. For example, the ratio of the weight of the porous organometallic compound particles to the weight of the second metal precursor in the second metal precursor solution may be 2 to 3.

Within the above range, an initial nucleation energy of lithium electrodeposition may be reduced, thereby enabling lithium to be more easily electrodeposited between the anode current collector and the anode mixture layer. In addition, reversibility of lithium storage may be enhanced, thereby improving battery cycle life characteristics.

After stirring, filtration, washing, and centrifugation, drying may be performed to obtain porous organometallic compound particles including a second metal.

The anode for a secondary battery according to the present disclosure includes an anode current collector and an anode mixture layer disposed on one surface of the anode current collector.

The anode current collector may include, for example, a copper foil, nickel foil, stainless steel foil, titanium foil, nickel foam, copper foam, or a polymer substrate coated with a conductive metal. The thickness of the anode current collector may be, for example, 10 μm to 50 μm, but is not limited thereto.

The anode mixture layer may be disposed on one surface or both surfaces of the anode current collector.

The anode mixture layer includes the above-described porous organometallic compound particle including carbon, nitrogen, and a metal and having a median particle diameter of 100 nm or more and less than 200 nm. Details of the porous organometallic compound particles may be as described above.

According to exemplary embodiments, the content of the porous organometallic compound particles based on the total weight of the anode mixture layer may be 60 wt % to 95 wt %. For example, the content of the porous organometallic compound particles based on the total weight of the anode mixture layer may be 70 wt % to 90 wt %. Within this range, delamination between the anode mixture layer and the anode current collector may be prevented, while lithium may be induced to be electrodeposited between the anode mixture layer and the anode current collector.

According to exemplary embodiments, the anode mixture layer may further include a binder or a conductive material.

The binder may include polyvinylidene fluoride (PVDF), poly(vinylidene fluoride-co-hexafluoropropylene), polyacrylonitrile, polymethyl methacrylate, acrylonitrile butadiene rubber (NBR), poly(butadiene) rubber (BR), styrene-butadiene rubber (SBR) or the like.

The binder may be included in an amount of 5 wt % to 15 wt % based on the total weight of the anode mixture layer.

For example, the anode mixture layer may further include a thickener such as carboxymethyl cellulose (CMC).

The conductive material may be added to the anode mixture layer to enhance the conductivity thereof and/or the mobility of lithium ions or electrons. For example, the conductive material may include carbon-based conductive materials such as graphite, carbon black, acetylene black, Ketjen black, graphene, carbon nanotubes, vapor-grown carbon fibers (VGCF), and carbon fibers; and/or metal-based conductive materials such as tin, tin oxide, and titanium oxide; as well as perovskite materials such as LaSrCoO₃, and LaSrMnO₃, but is not limited thereto.

The conductive material may be included in an amount of 5 wt % to 30 wt % based on the total weight of the anode mixture layer. For example, the conductive material may be included in an amount of 5 wt % to 20 wt % or 5 wt % to 15 wt % based on the total weight of the anode mixture layer. Within this range, an increase in internal pressure of the battery due to volume changes in the electrode assembly during charge and discharge of the battery may be suppressed.

The density of the anode mixture layer may be 0.1 g/cm³ to 1 g/cm³. According to exemplary embodiments, the density of the anode mixture layer may be 0.3 g/cm³ to 0.7 g/cm³.

For example, an anode slurry may be prepared by mixing the porous organometallic compound particles and a solvent. The anode slurry may be coated or deposited onto the anode current collector, and then dried and roll-pressed to prepare the anode mixture layer.

The coating process may be performed using methods such as gravure coating, slot die coating, simultaneous multilayer die coating, imprinting, doctor blade coating, dip coating, bar coating or casting, etc., but is not limited thereto.

In some embodiments, an anode 140 may include an anode mixture layer in the form of lithium metal formed through a deposition or coating process.

Non-limiting examples of the solvent used in the preparation of the anode slurry may include N-methyl-2-pyrrolidone (NMP), dimethylformamide, dimethylacetamide, N,N-dimethylaminopropylamine, ethylene oxide, tetrahydrofuran or the like.

According to exemplary embodiments, the anode may further include a metal layer interposed between the anode mixture layer and the anode current collector. The metal layer may include a metal having lithium affinity, thereby more strongly inducing lithium to be electrodeposited on the anode current collector.

According to exemplary embodiments, the metal layer may include at least one selected from the group consisting of Ag, Zn, Al, Mg, Au, Si and Sb. For example, the metal layer may include Ag.

The metal layer may be formed using a method known in the art. For example, the metal layer may be formed using vapor deposition or atomic layer deposition.

A lithium secondary battery according to the present disclosure includes an anode and a cathode disposed opposite the anode.

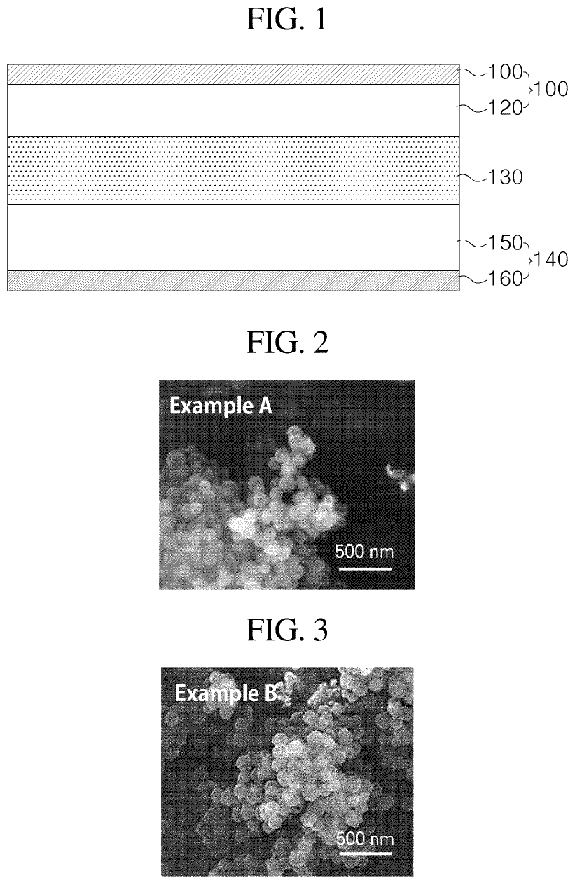

FIG. 1 is a schematic cross-sectional view illustrating a secondary battery according to exemplary embodiments.

Referring to FIG. 1, the secondary battery may include a cathode 100, the anode 140 disposed opposite the cathode 100, and a solid electrolyte layer 130 disposed between the cathode 100 and the anode 140 and including the solid electrolyte.

The cathode 100 may include a cathode current collector 110 and a cathode active material layer 120 disposed on at least one surface of the cathode current collector 110.

The cathode current collector 110 may include stainless steel, nickel, aluminum, titanium, or an alloy thereof. The cathode current collector 110 may also include aluminum or stainless steel having a surface treated with carbon, nickel, titanium, or silver. The thickness of the cathode current collector may be, for example, 10 μm to 50 μm.

The cathode active material layer 120 may include a cathode active material. The cathode active material may include a compound capable of reversibly intercalating and deintercalating lithium ions.

According to exemplary embodiments, the cathode active material may include a lithium-nickel metal oxide. The lithium-nickel metal oxide may further include at least one of cobalt (Co), manganese (Mn) and aluminum (Al).

In some embodiments, the cathode active material or the lithium-nickel metal oxide may include a layered structure or a crystal structure represented by Formula 1 below.

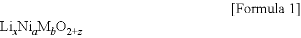

In Formula 1, x, a, b and z may satisfy 0.9≤x≤1.2, 0.6≤a≤0.99, 0.01≤b≤0.4, and −0.5≤z≤0.1. As described above, M may include Co, Mn and/or Al.

The chemical structure represented by Formula 1 indicates a bonding relationship among elements included in the layered structure or the crystal structure of the cathode active material, and does not exclude the presence of additional elements. For example, M includes Co and/or Mn, and Co and/or Mn may be provided as main active elements of the cathode active material together with Ni. Here, it should be understood that Formula 1 is provided to express the bonding relationship between the main active elements, and is a formula encompassing the introduction and substitution of additional elements.

In one embodiment, the cathode active material may further include auxiliary elements which are added to the main active elements, in order to enhance chemical stability thereof or the layered structure/crystal structure. The auxiliary element may be incorporated into the layered structure/crystal structure together with the main active elements to form bonds, and it should be understood that this case is also included within the chemical structure range represented by Formula 1.

The auxiliary element may include, for example, at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may also act, for example, as an auxiliary active element that contributes to the capacity/output activity of the cathode active material together with Co or Mn, such as Al.

For example, the cathode active material or the lithium-nickel metal oxide may include a layered structure or a crystal structure represented by Formula 1-1 below.

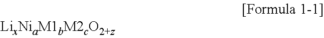

In Formula 1-1, M1 may include Co, Mn and/or Al. M2 may include the auxiliary elements described above. In Formula 1-1, x, a, b, c and z may satisfy 0.9≤x≤1.2, 0.6≤a≤0.99, 0.01≤b+c≤0.4, and −0.5≤z≤0.1.

The cathode active material may further include a coating element or a doping element. For example, elements which are substantially the same as or similar to the above-described auxiliary elements may be used as the coating element or the doping element. For example, the above-described elements may be used alone or in combination of two or more thereof as the coating element or the doping element.

The coating element or the doping element may be present on the surface of lithium-nickel metal oxide particles, or may penetrate through the surface of the lithium-nickel metal oxide particles to be incorporated into the bonding structure represented by Formula 1 or Formula 1-1 above.

The cathode active material may include a nickel-cobalt-manganese (NCM)-based lithium oxide. In this case, an NCM-based lithium oxide having an increased content of nickel may be used.

Nickel (Ni) may serve as a transition metal associated with the output and capacity of the lithium secondary battery. Therefore, as described above, by employing a high-nickel-content (high-Ni) composition in the cathode active material, a high-capacity cathode and a high-capacity lithium secondary battery may be provided.

However, as the Ni content increases, the long-term storage stability and cycle life stability of the cathode or the secondary battery may be relatively reduced, and side reactions with the electrolyte may also increase. Nevertheless, according to exemplary embodiments, by including Co, the cycle life stability and capacity retention characteristics may be improved by Mn, while electrical conductivity is maintained.

The content of Ni (e.g., the molar fraction of nickel based on the total molar amount of nickel, cobalt and manganese) in the NCM-based lithium oxide may be 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

In some embodiments, the cathode active material may include a lithium cobalt oxide-based active material, a lithium manganese oxide-based active material, a lithium nickel oxide-based active material, or a lithium iron phosphate (LFP)-based active material (e.g., LiFePO₄).

In some embodiments, the cathode active material may include, for example, a manganese (Mn)-rich active material, a lithium (Li)-rich layered oxide (LLO)/over-lithiated oxide (OLO)-based active material, or a cobalt (Co)-less active material, which has a chemical structure or a crystal structure represented by Formula 2 below.

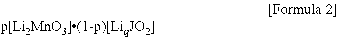

In Formula 2, p and q may satisfy 0<p<1, and 0.9≤q≤1.2, and J may include at least one element selected from Mn, Ni, Co, Fe, Cr, V, Cu, Zn, Ti, Al, Mg and B.

The content of the cathode active material may be about 50 wt % to 90 wt % based on a total weight of the cathode active material layer 120. According to exemplary embodiments, the content of the cathode active material may be about 60 wt % to 85 wt % based on the total weight of the cathode active material layer 120.

The cathode active material layer 120 may further include a solid electrolyte. Accordingly, a decrease in ion mobility due to the absence of a liquid electrolyte may be compensated. For example, the solid electrolyte may include a sulfide-based solid electrolyte or an oxide-based solid electrolyte.

The content of the solid electrolyte based on the total weight of the cathode active material layer 120 may be about 5 wt % to 40 wt %.

For example, a cathode slurry may be prepared by mixing a solvent and the cathode active material. The cathode slurry may be coated on the cathode current collector 110, followed by drying and roll-pressing to prepare the cathode active material layer 120. The coating process may be performed using methods such as gravure coating, slot die coating, simultaneous multilayer die coating, imprinting, doctor blade coating, dip coating, bar coating or casting, etc., but is not limited thereto. The cathode active material layer may further include a binder and optionally may further include a conductive material, a thickener or the like.

Non-limiting examples of the solvent used in the preparation of the cathode slurry may include N-methyl-2-pyrrolidone (NMP), dimethylformamide, dimethylacetamide, N,N-dimethylaminopropylamine, ethylene oxide, tetrahydrofuran or the like.

The binder may include polyvinylidene fluoride (PVDF), poly(vinylidene fluoride-co-hexafluoropropylene), polyacrylonitrile, polymethyl methacrylate, acrylonitrile butadiene rubber (NBR), poly(butadiene) rubber (BR), styrene-butadiene rubber (SBR) and the like. In one embodiment, a PVDF-based binder may be used as the cathode binder.

The conductive material may be added to the cathode active material layer to enhance the conductivity thereof and/or the mobility of lithium ions or electrons. For example, the conductive material may include carbon-based conductive materials such as graphite, carbon black, acetylene black, Ketjen black, graphene, carbon nanotubes, vapor-grown carbon fibers (VGCF), and carbon fibers; and/or metal-based conductive materials such as tin, tin oxide, and titanium oxide; as well as perovskite materials such as LaSrCoO₃, and LaSrMnO₃, but is not limited thereto.

The cathode slurry may further include a thickener and/or a dispersant, as needed. In one embodiment, the cathode slurry may include a thickener such as carboxymethyl cellulose (CMC).

The anode 140 may include an anode current collector 160 and an anode mixture layer 150 disposed on at least one surface of the anode current collector 160. The anode 140, the anode mixture layer 150, and the anode current collector 160 may be the same as described above.

In some embodiments, the solid electrolyte layer 130 including a solid electrolyte may be interposed between the cathode 100 and the anode 140 within the electrode assembly. For example, an electrode cell may be defined by the cathode 100, the anode 140, and the solid electrolyte layer 130, and a plurality of the electrode cells may be stacked to form an electrode assembly. For example, the electrode assembly may be formed by winding, stacking, folding or the like.

The solid electrolyte layer 130 may include an inorganic solid electrolyte and/or an organic solid electrolyte. For example, the inorganic solid electrolyte may include an oxide-based solid electrolyte or a sulfide-based solid electrolyte, and the organic solid electrolyte may include a polymer electrolyte or the like.

In an exemplary embodiment, the solid electrolyte layer 130 may include an argyrodite-type compound which may be represented by Li₇₋ₓPS₆₋ₓClₓ (0≤x≤2), Li₇₋ₓPS₆₋ₓBrₓ (0≤x≤2), or Li₇₋ₓPS₆₋ₓIₓ (0≤x≤2).

The solid electrolyte layer 130 may further include a binder together with the solid electrolyte. The solid electrolyte layer 130 may include a polymer material substantially the same as or similar to the above-described binder for forming the cathode.

For example, a solid electrolyte composition including a solid electrolyte and a binder may be prepared, and then the solid electrolyte layer 130 may be formed through a press molding process using a mold.

The cathode active material layer 120 and the anode mixture layer 150 may each be in contact with the solid electrolyte layer 130. For example, the cathode active material layer 120 may be in contact with one surface of the solid electrolyte layer 130, and the anode mixture layer 150 may be in contact with the other surface of the solid electrolyte layer 130 facing the one surface.

For example, electrode tabs (cathode tabs and anode tabs) may protrude from the cathode current collector and the anode current collector, respectively, and may extend to one side of a case. The electrode tabs may be welded together with the one side of the case and connected to electrode leads (a cathode lead and an anode lead) that extend or are exposed to the outside of the case.

For example, a pouch-type case, a prismatic case, a cylindrical case, or a coin-type case, etc. may be used as the case.

Hereinafter, the embodiments of the present disclosure will be further described with reference to specific experimental examples. The examples and comparative examples included in the experimental examples are merely illustrative of the present disclosure and do not limit the scope of the appended claims. It will be apparent to those skilled in the art that various changes and modifications to the examples can be made within the scope and technical spirit of the present disclosure, and it is also understood that such changes and modifications fall within the scope of the appended claims.

### Preparation of Porous Organometallic Compound Particles

### Example A

A metal precursor solution and a nitrogen-containing organic ligand precursor solution were prepared by dissolving 3 g of zinc acetate and 16.8 g of 2-methylimidazole in 50 mL of distilled water, respectively. The metal precursor solution was added to the nitrogen-containing organic ligand precursor solution at a rate of 10 mL/s, and the resulting mixture was stirred for 30 minutes. After the stirring, the mixture was allowed to stand for 24 hours to precipitate a metal-organic framework.

The precipitate was filtered and washed with distilled water, and then centrifuged for 10 minutes to separate the washing solution from the precipitate. This process was repeated three times.

The washed precipitate was dried in an oven at 80° C. for 6 hours or more, and then heat-treated at 800° C. for 2 hours under an Ar gas atmosphere. The median particle diameter (D50) of the porous organometallic compound particles was about 100 nm.

FIG. 2 is a TEM image of the porous organometallic compound particles of Example A.

### Example B

Porous organometallic compound particles were prepared in the same manner as in Example A, except that the metal precursor solution was added to the nitrogen-containing organic ligand precursor solution at a rate of 15 mL/s. The median particle diameter (D50) of the porous organometallic compound particles was about 120 nm.

FIG. 3 is a TEM image of the porous organometallic compound particles of Example B.

### Example C

Porous organometallic compound particles were prepared in the same manner as in Example A, except that the metal precursor solution was added to the nitrogen-containing organic ligand precursor solution at a rate of 25 mL/s. The median particle diameter (D50) of the porous organometallic compound particles was about 150 nm.

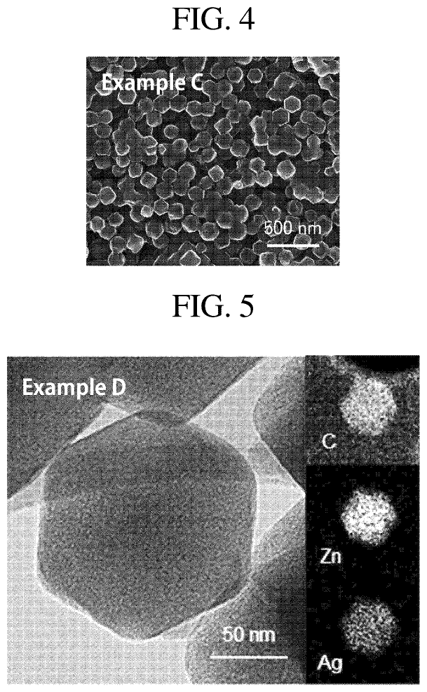

FIG. 4 is a TEM image of the porous organometallic compound particles of Example C.

### Example D

0.2 g of the porous organometallic compound particles of Example A were dispersed in 30 mL of distilled water to prepare a dispersion, and 0.0944 g of silver nitrate (AgNO₃) was dissolved in 30 mL of distilled water to prepare a second metal solution.

The second metal solution was added to the dispersion and stirred for 12 hours. A precipitate was obtained by centrifugation, washed with distilled water, and then centrifuged for 10 minutes to separate the washing solution from the precipitate, and this process was repeated three times.

The precipitate obtained after washing was dried in an oven at 80° C. for 6 hours or more to obtain porous organometallic compound particles including a second metal.

FIG. 5 is a TEM image and EDS elemental mapping images of carbon, zinc, and silver of a porous organometallic compound particle of Example D.

### Comparative Example A

Porous organometallic compound particles were prepared in the same manner as in Example A, except that 11.2 g of 2-methylimidazole was used. The median particle diameter (D50) of the porous organometallic compound particles was about 400 nm.

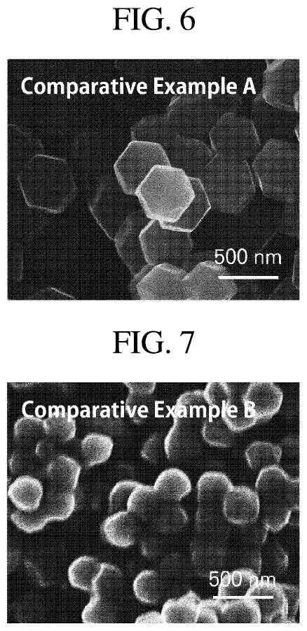

FIG. 6 is a TEM image of the porous organometallic compound particles of Comparative Example A.

### Comparative Example B

Porous organometallic compound particles were prepared in the same manner as in Example A, except that 14.0 g of 2-methylimidazole was used. The median particle diameter (D50) of the porous organometallic compound particles was about 200 nm.

FIG. 7 is a TEM image of the porous organometallic compound particles of Comparative Example B.

### Manufacture of Battery

### Examples 1 to 5, and 8, and Comparative Examples 1 and 2

An anode slurry was prepared by mixing a solid mixture having compositions of a porous organometallic compound, a conductive material, and a binder shown in Table 1 with N-methyl-2-pyrrolidone. The anode slurry was applied onto one surface of a stainless steel (SUS) foil using a doctor blade and dried at 60° C. Subsequently, vacuum drying was further performed at 120° C. for 2 hours to fabricate an anode. Carbon black was used as the conductive material, and polyvinylidene fluoride was used as the binder.

A solid electrolyte sheet was prepared by pressing 0.1 g of Li₆PS₅Cl at 100 MPa. On one surface of the solid electrolyte sheet, 0.01 g of a cathode material mixture (LiNi_{0.8}Co_{0.1}Mn_{0.1}O₂:Li₆PS₅Cl:Super-C65=72:27:1; weight ratio) was pressed at 300 MPa to form a cathode layer. The anode was disposed on the other surface of the solid electrolyte sheet, and the resulting structure was further pressed at 50 MPa to manufacture a battery.

### Example 6

A battery was manufactured in the same manner as in Example 1, except that, instead of stainless steel foil, one surface of a copper foil was coated with silver (Ag) to a thickness of 10 μm and a density of 0.4 g/cm³, and the anode slurry was applied onto the silver coating.

### Example 7

A battery was manufactured in the same manner as Example 6, except that silver (Ag) was coated at a density of 0.7 g/cm³.

### Reference Example

A battery was manufactured in the same manner as in Example 6, except that stainless steel foil was used as the anode.

TABLE 1

| | | Anode slurry solids composition (wt %) | | | |
|---|---|---|---|---|---|
| | Anode | Porous organometallic | | Con- | |
| | current | compound particles | | ductive | |
| | collector | Type | Content | material | Binder |
| Example 1 | SUS foil | Example A | 90 | — | 10 |
| Example 2 | SUS foil | Example A | 80 | 10 | 10 |
| Example 3 | SUS foil | Example A | 70 | 20 | 10 |
| Example 4 | SUS foil | Example B | 90 | — | 10 |
| Example 5 | SUS foil | Example C | 90 | — | 10 |
| Example 6 | SUS foil + | Example A | 90 | — | 10 |
| | Ag coating | | | | |
| | (Density | | | | |
| | 0.4 g/cm³) | | | | |
| Example 7 | SUS foil+ | Example A | 90 | — | 10 |
| | Ag coating | | | | |
| | (Density | | | | |
| | 0.7 g/cm³) | | | | |
| Example 8 | SUS foil | Example D | 90 | — | 10 |
| Comparative | SUS foil | Comparative | 90 | — | 10 |
| Example 1 | | Example A | | | |
| Comparative | SUS foil | Comparative | 90 | — | 10 |
| Example 2 | | Example B | | | |
| Reference | SUS foil | — | — | — | — |
| Example | | | | | |

### Experimental Example 1: Analysis of Lithium Storage Behavior

The batteries of the examples and comparative examples were charged under a pressure of 25 MPa and at a temperature of 60° C., at a rate of 0.1 C with a current density of 2.0 mAh/cm². The batteries were then disassembled, and cross-sections of the anodes were observed to analyze lithium storage behavior.

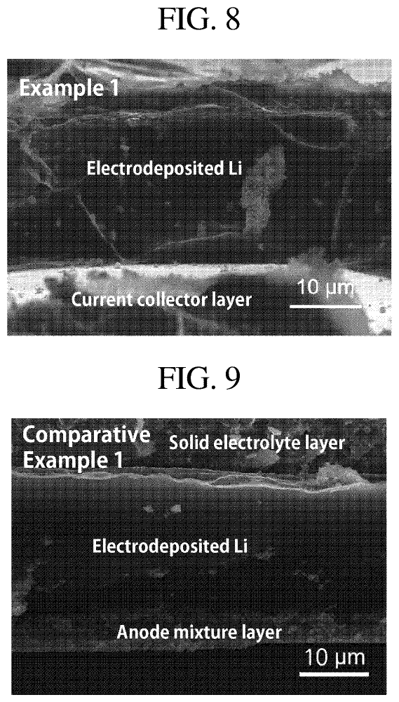

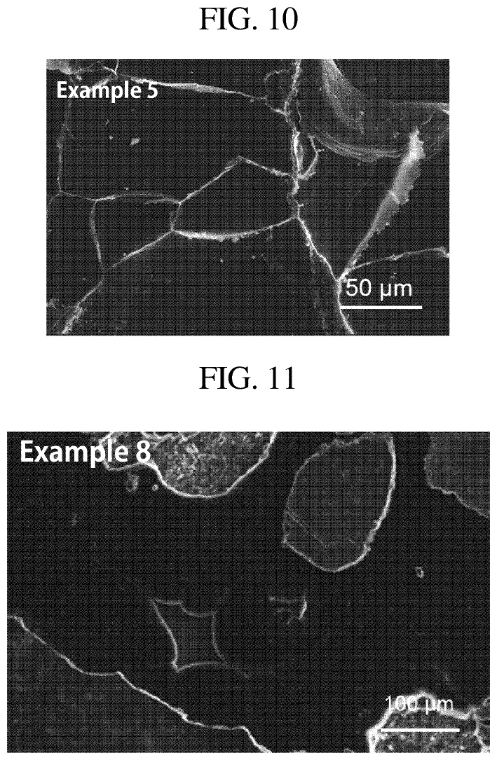

FIG. 8 is a scanning electron microscope (SEM) image of a cross-section of an anode of Example 1 after charging FIG. 9 is a SEM image of a cross-section of an anode of Comparative Example 1 after charging, FIG. 10 is an SEM image of a cross-section of an anode of Example 5 after charging, and FIG. 11 is an SEM image of a cross-section of an anode of Example 8 after charging.

Referring to FIGS. 8 to 11, lithium was electrodeposited between the anode current collector and the anode mixture layer in the anodes of Examples 1, 5 and 8, whereas lithium was electrodeposited between the anode mixture layer and the solid electrolyte layer in the anode of Comparative Example 1.

### Experimental Example 2: Analysis of Internal Battery Pressure Changes

The batteries of the examples and comparative examples were charged and discharged at 60° C. and an areal capacity of 4 mAh/cm² under a rate of 0.33 C, and a maximum change in internal pressure of the batteries was measured and is shown in Table 2.

### Experimental Example 3: Evaluation of Charge-Discharge Efficiency

The batteries of the examples and comparative examples were charged and discharged at a rate of 0.1 C based on an areal capacity of 4 mAh/cm². The initial charge-discharge efficiency was calculated as a ratio of a discharge capacity to a charge capacity, and is shown in Table 2.

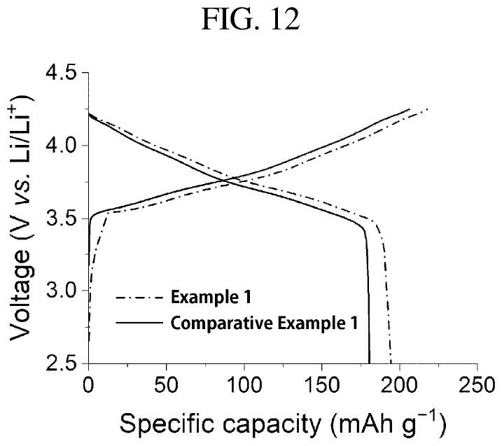

FIG. 12 is a graph of charge-discharge curves for Example 1 and Comparative Example 1 according to capacity.

TABLE 2

| | Maximum pressure | Initial |
|---|---|---|
| | increase during | charge-discharge |
| | charging (ΔP, MPa) | efficiency (%) |
| Example 1 | 0.8 | 89.2 |
| Example 2 | 0.6 | 90.1 |
| Example 3 | 1.1 | 88.0 |
| Example 4 | 0.8 | 89.4 |
| Example 5 | 0.9 | 89.0 |
| Example 6 | 0.8 | 89.7 |
| Example 7 | 1.0 | 89.4 |
| Example 8 | 0.8 | 89.4 |
| Comparative Example 1 | 1.2 | 87.7 |
| Comparative Example 2 | 1.1 | 87.9 |
| Reference Example | 1.7 | 87.0 |

Referring to Table 2 and FIG. 12, in the batteries of the examples, the anode mixture layer including porous organometallic compound particles functioned as a buffer, thereby suppressing an increase in internal pressure of the battery even after charging. In addition, the batteries of the examples provided improved charge-discharge efficiency.

In contrast, in the batteries of the comparative examples, lithium was electrodeposited at an interface between the solid electrolyte layer and the anode mixture layer, thereby causing a significant increase in internal pressure during charging. In addition, the charge-discharge efficiency of the batteries of the comparative examples was deteriorated compared to that of the batteries of the examples.

The contents described above are merely examples of applying the principles of the present disclosure, and other configurations may be further included without departing from the scope of the present disclosure.

1. A porous organometallic compound particle comprising carbon, nitrogen, and a metal and having a median particle diameter of 100 nm or more and less than 200 nm.

2. The porous organometallic compound particle according to claim 1, wherein the porous organometallic compound particle has a median particle diameter of 100 nm to 160 nm.

3. The porous organometallic compound particle according to claim 1, wherein the porous organometallic compound particle has a rhombic dodecahedron structure.

4. The porous organometallic compound particle according to claim 1, wherein the metal comprises one or more of Zn, Co, Cu, Ti, Hf, Zr, Ni, Mg, V, Cr, Fe and Al.

5. The porous organometallic compound particle according to claim 1, wherein the metal comprises a first metal including one or more of Zn, Co, Cu, Ti, Hf, Zr, Ni, Mg, V, Cr, Fe and Al, and a second metal including one or more of Pt, Al, Mg, Zn, Ag, Au, Si, Sb and Sn.

6. A method for preparing a porous organometallic compound particle, comprising:
adding a metal precursor solution to a nitrogen-containing organic ligand precursor solution to precipitate a metal-organic framework; and
obtaining the metal-organic framework and heat-treating it,
wherein a ratio of a weight of the nitrogen-containing organic ligand in the nitrogen-containing organic ligand precursor solution to a weight of the metal precursor in the metal precursor solution is 4.7 or more.

7. The method for preparing a porous organometallic compound particle according to claim 6, wherein the ratio of the weight of the nitrogen-containing organic ligand in the nitrogen-containing organic ligand precursor solution to the weight of the metal precursor in the metal precursor solution is 5 to 10.

8. The method for preparing a porous organometallic compound particle according to claim 6, wherein the content of the metal precursor in the metal precursor solution is 0.01 g/mL to 0.2 g/mL.

9. The method for preparing a porous organometallic compound particle according to claim 6, wherein the content of the nitrogen-containing organic ligand in the nitrogen-containing organic ligand precursor solution is 0.2 g/mL to 1 g/mL.

10. The method for preparing a porous organometallic compound particle according to claim 6, wherein the heat treatment is performed at a temperature of 700° C. to 1,000° C. for 1 to 3 hours.

11. The method for preparing a porous organometallic compound particle according to claim 6, further comprising preparing a porous organometallic compound particle comprising a second metal using a second metal precursor solution after the heat treatment.

12. An anode for a secondary battery comprising:
an anode current collector, and
an anode mixture layer disposed on one surface of the anode current collector and comprising a porous organometallic compound particle including carbon, nitrogen, and a metal and having a median particle diameter of 100 nm or more and less than 200 nm.

13. The anode for a secondary battery according to claim 12, wherein the content of the porous organometallic compound particle is 60% by weight to 95% by weight based on a total weight of the anode mixture layer.

14. The anode for a secondary battery according to claim 12, further comprising a metal layer interposed between the anode mixture layer and the anode current collector.

15. The anode for a secondary battery according to claim 14, wherein the metal layer comprises at least one selected from the group consisting of Ag, Zn, Al, Mg, Au, Si and Sb.

16. The anode for a secondary battery according to claim 12, wherein the anode mixture layer further comprises a binder or a conductive material.

17. A lithium secondary battery comprising:
the anode according to claim 12; and
a cathode disposed opposite the anode.

18. The secondary battery according to claim 17, further comprising a solid electrolyte layer interposed between the anode and the cathode.
